(19) United States
(12) Patent Application Publication
(10) Pub. No.: US 2008/0089287 A1
(43) Pub. Date: Apr. 17, 2008

(54) Broadcast-based communication in a radio or wireless access network to support mobility

(75) Inventors: Mats Fredrik Sagfors, Kyrkslatt (FI); Shyam Chakraborty, Espoo (FI); Johan Torsner, Masaby (FI)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson (publ), Stockholm (SE)

(21) Appl. No.: 11/546,569

(22) Filed: Oct. 12, 2006

(51) Int. Cl. H04Q 7/00

(52) U.S. Cl. 370/331

(57) ABSTRACT

In a radio or wireless access network, packets to be transmitted to a mobile radio are broadcast over a transport network to a set of associated radio access points, where each set of associated radio access points corresponds to a broadcast group. Each access point monitors packets broadcast to it broadcast group to determine if the access point should retrieve the packet. Rather than establishing packet tunnels to specific access points to transport packets to be transmitted to a mobile station through a transport network, those packets simply are broadcast over the transport network to the relevant broadcast group(s). Select diversity may be used where the mobile selects which access point transmits a particular packet to the mobile station. Alternatively, the network may decide which access point transmits a particular packet to the mobile station. This approach greatly facilitates cost-efficient and fast handovers of a mobile connection between access points in a wireless network.

### RELATED APPLICATION

This application is related to a commonly-assigned application entitled “Select Diversity For Radio Communications,” filed on Oct. 12, 2006, and having Ser. No. 11/______, (Atty. Ref. 2380-1016), the disclosure of which is incorporated here by reference.

### TECHNICAL FIELD

The technical field relates to cellular radio communications, and in particular, to providing packets efficiently to multiple access points in a cellular radio communications system.

### BACKGROUND

Handover is an important feature in all modern cellular systems where an established communications link or connection with a mobile radio is transferred from one cell (i.e., a geographical coverage area) to another cell to accommodate movement of the mobile radio and/or changing radio conditions. A radio base station is associated with each cell, and a network control node such as a radio network controller (RNC) or base station controller (BSC) may control multiple radio base stations. When new radio access technologies are developed, like in the long-term evolution (LTE) of third generation cellular communications like 3GPP, there is a need to define efficient handover schemes that provide lossless, seamless, and fast handover of a connection with a mobile without packet duplicates.

High-Speed Downlink Packet Access (HSDPA) is specified in 3GPP Release 5. With HSDPA, wideband code division multiple access (WCDMA) cellular systems include additional transport and control channels, such as the high-speed downlink shared channel (HS-DSCH), which provides enhanced support for interactive, background and, to some extent, streaming services. Downlink (i.e., from the radio network to the mobile radio) systems that provide High-Speed Downlink Packet Access (HSDPA) have a hybrid automatic repeat request (HARQ) protocol that is used between the radio base station (sometimes called a Node B in 3G) and the mobile radio (called a user equipment (UE) in 3G) to retransmit packets that are not received or erroneously received at the mobile station. That HARQ protocol is handled at a media access control (MAC) protocol layer. Acknowledged mode (AM) packet retransmissions may also be performed between an RNC and UE (typically at a radio link control (RLC) protocol layer) for applications requiring a low packet loss rate.

When a handover cell change to a new base station is performed at a specified “activation time,” the data packets stored in one or more transmit buffers in a current base station to be sent to the mobile radio are “flushed,” which implies that some data packets may be discarded. To compensate for this, RLC level retransmissions from the radio network controller will ensure that the RLC control entity retransmits those data packets via the new base station so that no data loss occurs. On the other hand, if a connection is established or is otherwise operating in an unacknowledged mode (UM), lost or erroneously-received data packets are not retransmitted.

For conversational services, data packets may be sent in the unacknowledged mode because the strict delay “budget” associated with a packet data conversational service does not tolerate delays associated with packet retransmissions. A problem then in this situation is that any data present in the current radio base station during the cell change and buffer flushing is lost. Although this data packet loss may be acceptable for conversational services, it is unacceptable as a general mobility solution when data integrity is important. Thus, with HSDPA operating in unacknowledged mode, it is difficult to achieve both uninterrupted/seamless and lossless handovers.

Another problem with the hard handover cell change mechanism of HS-DSCH relates to radio channel fading. Ideally, the downlink transmission between a radio base station and the user equipment should occur in a best cell currently showing the most favorable radio conditions for this downlink transmission. But this ideal situation is very hard to achieve with the mechanism described above, since the hard handover procedure is typically much slower than the dynamics of the channel fading. Thus, the downlink data may end up being transmitted in a cell that is not the best cell at the moment.

Soft-handover, which is a form of macro-diversity reception, is used in 3G systems to handle this problem. A mobile user equipment in soft-handover receives the same information from a set of multiple cells or transmitters. That cell set usually always includes the best cell—even in cases when the fading changes rapidly. However, soft-handover comes with several drawbacks which is why soft-handover was abandoned as a solution for Release-5 HS-DSCH and for downlink LTE in the evolving 3G systems.

First, soft-handover requires very strict network synchronization which complicates network deployment. The transmissions from multiple base station nodes must be simultaneous. Second, soft-handover does not permit independent adaptation of modulation and coding in each cell because the encoding and modulation scheme must be the same from all transmitters in the soft-handover communication. The HS-DSCH uses both link adaptation (with HARQ) and multi-user scheduling carried out from the base station rather than a base station controller node. But base station-based, multi-user scheduling is difficult to achieve along with soft handover because the simultaneous transmission scheduling in multiple base stations must be rigorously coordinated. The inventors recognized the need to facilitate distributed scheduling and link adaptation (with HARQ) in each radio base station so that the downlink transmission occurs in the best cell. In UTRAN, the cell change operation is primarily orchestrated by the RNC, which means a relatively long handover time due to the signalling transfers between the RNC, the mobile equipment, and the radio base stations. Third, link-layer efficiency can still be increased by ensuring that the transmission is always carried out in the best cell. Finally, packet transmission delays (e.g., caused by aforementioned losses and subsequent re-transmission) resulting from handover cell changes can still be further reduced.

Another issue to address is that user-plane architectures in the 3 GPP UTRAN long-term evolution are moving towards a simplified network architecture, where a user plane Anchor Node (AN) or Access Gateway (AGW), like the RNC in UTRAN, only performs limited functions. For example, the move would substantially reduce or even eliminate handover and other mobility management functions performed by the anchor node, and off-load those functions to the radio base station nodes. But a consequence of such a functionality change is that acknowledged (AM) mode packet communications is not supported in the anchor node.

The inventors also recognized a problem associated with handover in the transport network that transports packets from a gateway or an anchor node like a radio network controller (RNC) to particular base stations involved in a handover. FIG. 1 shows a radio access network (RAN) 10 with a gateway (GW) node 12 such as an RNC sending packets (e.g., packet # 5 is shown) for a connection to a mobile station 18 to an old base station (BS 1) 14 over a packet tunnel # 1 (an example of a packet tunnel is a GTP-U tunnel). The same packet # 5 is also sent in parallel to a new handover base station (BS2) 16 that will take over the connection via a second packet tunnel # 2. Specifically, current soft and hard handover techniques require that multiple copies of the same packet for the mobile station be sent from the gateway or anchor node through the transport network to each of the base stations involved in a handover. Accordingly, current handover procedures establish transport network connections or “tunnels” from the anchor node to the handover base stations.

FIG. 2 illustrates an example transport network 20 as part of the RAN 10 in which two parallel tunnels are established through the transport network 20 between the gateway (GW) 12 and the two base stations BS1 and BS2 involved in a handover. The transport network 20 includes multiple routing nodes 22, 24, 26, and 28. In this example, when the gateway 12 sends a copy of each packet to be transmitted to the mobile station over parallel packet paths or tunnels established to each of the base stations BS1 and BS2 involved in the handover, (packet # 5 is sent in parallel in the figure over the two tunnels), both packets must be individually routed through four routers. The “cost” in terms of extra traffic load and delays in the transport network 20 associated with sending duplicates of the same packet and establishing separate packet connections or tunnels is very high. If more than two base stations are involved in the handover, they would also receive copies of the same packets over their respective established packet connections or tunnels, further increasing the load in the transport network.

That load is further exacerbated if packet forwarding is used as a method to ensure packet integrity during handover. FIG. 1 shows that both base stations BS1 and BS2 have a packet buffer for buffering packets before transmitting them to the mobile station 18. The old base station 14 must forward packets 3 and 4 stored in its buffer to the new base station 16. But this packet forwarding requires additional routing in the transport network 20 of FIG. 2, and further adds to delays in the handover operation.

These transport network delays are particularly troublesome if very fast and very frequent handovers are to be performed. For example, the select diversity cell selection technology described in related, commonly-assigned application entitled “Select Diversity For Radio Communications,” filed on October ** , 2006, provides very fast handover over the radio/air interface. But significant transport network delays can undermine the speed that select diversity offers.

### SUMMARY

In a radio or wireless access network (the term radio is used here to include any form of wireless communication), packets to be transmitted to a mobile radio are broadcast (broadcast as used here includes multi-cast) to a particular set of associated radio access points in a transport network. Each set of associated radio access points corresponds to a broadcast group. A broadcast group is not limited to a particular type of association or broadcast medium. Some non-limiting examples include a bus segment broadcast medium implementing, e.g., the Ethernet protocol, a wireless broadcast medium implementing, e.g., the High Speed Downlink Packet Access (HSDPA) protocols of 3GPP, or a satellite medium for broadcasting packets over a wide area.

So a broadcast group is associated with multiple access points. An access point is a wireless transceiver node in the radio access network. A base station may include multiple access points. Each access point monitors packets broadcasted to its broadcast group to determine if the access point should retrieve the packet. Rather than establishing packet tunnels to specific access points to transport packets to be transmitted to a mobile station through a transport network, those packets are simply broadcast to one or more broadcast groups over the transport network. No re-routing of packets is needed as long as the mobility takes place within the coverage of access points interconnected with the same broadcast medium. This approach greatly facilitates cost-efficient and fast handovers of a mobile connection between access points in a wireless network. In contrast to the conventional approaches described above, no point-to-point packet connections or tunnels need be established to access points associated with a communication with the mobile station or with a handover involving that communication.

If desired, select diversity may be used where the mobile selects which access point transmits a particular packet downlink to the mobile station. Alternatively, the network may decide which access point transmits a particular packet downlink to the mobile station. In any event, the broadcasting of data packets addressed to a mobile station to a set of access points likely to be selected to transmit to the mobile station is much more efficient than having to establish packet tunnels to those multiple access points.

In an example embodiment, a radio access network node supports the mobility of a mobile radio communicating with a radio access network via one or more of plural radio access points. A first set of radio access points is associated with a first broadcast group, and a second set of radio access points is associated with a second broadcast group. Packets are received for transmission to the mobile station via one or more of the access points. One or more broadcast groups is identified that include an access point associated with the mobile station. One or more of the packets for transmission to the mobile station is broadcast to the identified broadcast group or groups. Each of the access points associated with the broadcast group can receive those broadcast packets.

The radio access node may be connected to or be a part of a transport network for transporting packets between the access points and the radio access network node. In one example implementation, the radio access network node is a router node that receives the packets from a gateway node external to the radio access network and routes them to the identified broad group or groups. Non-limiting example broadcast mediums include Ethernet bus segments, a satellite broadcast medium, or a terrestrial wireless medium, e.g., HSDPA. The radio access network can be any suitable radio access network including for example a cellular radio access network or a wireless local area network.

The first set of radio access points forming the first broadcast group may be associated with coverage cells located in the same geographic coverage area or proximate geographic coverage areas. Each access point is associated with one or more cells. The radio access node determines if the access point or points associated with the mobile station change, e.g., a handover is to occur or a candidate cell set is to be updated. If so, the node identifies which broadcast group or groups currently includes an access point associated with the mobile station.

A handover control node may be used to receive information associated with the mobile station regarding one or more conditions associated with cells in a candidate set used for handover operations. A new cell may be added to the candidate set, an existing cell deleted from the candidate set, or both based on the received information.

In an example embodiment, an access point in a transport network includes broadcast monitoring circuitry for monitoring packets broadcast to the corresponding broadcast group. As one example, the broadcast monitoring circuitry can monitor received broadcast packets using a carrier sense multiple access collision detect (CSMA/CD) protocol. A downlink packet buffer is connected to the broadcast monitoring circuitry for storing selected packets received from the broadcast. Control circuitry provides information so the broadcast monitoring circuitry can detect and select packets broadcast to the broadcast group that are intended for the mobile station and store them in the downlink packet buffer. For example, each broadcast packet includes an identifier for identifying that the packet is intended for transmission to a particular mobile station. The broadcast monitoring circuitry detects packets intended for the mobile station by checking the identifier of received broadcast packets with an identifier associated with the mobile station. The control circuitry can receive a packet selection signal from the mobile station, or it can receive a packet selection signal from a controlling entity in or connected to the transport network. If the access point is selected to transmit one of the packets in the downlink packet buffer, the one packet is provided from the downlink packet buffer to a scheduler for scheduling its transmission to the mobile station.

A packet communication with the mobile station may be associated with a candidate set of cells for the mobile radio that can potentially transmit packets to the mobile radio. The selection signal identifies a selected one of the candidate cells. The selection may be based on one or more factors including one or more radio conditions associated with the access point, one or more radio network conditions, or one or more mobile radio subscription conditions. In one example application, the access point is part of a radio base station that includes a transport network with plural access points grouped into one or more broadcast groups.

This packet broadcast technology may advantageously be used with select diversity in cellular radio communications to ensure that an optimal access point/cell under a current condition is selected for communicating with the mobile radio. In a preferred implementation of select diversity, the mobile radio selects an access point associated with a cell in the candidate set for transmitting a packet to the mobile radio. The radio access network may include at least one radio base station having a transport network, where each access point is associated with one or more cells, and where multiple candidate access points have an associated cell in a candidate set of cells for the mobile station receive packets for the mobile station broadcast over the transport network. One of the candidate access points having a cell in the candidate cell set is selected for transmitting a packet to the mobile radio. The mobile radio signals to the selected access point an indication to transmit the packet to the mobile radio. The mobile radio may select only one access point or it may select two or more access points in the candidate set to transmit the packet to the mobile radio. If the mobile selects two access points to transmit a packet to the mobile radio, those packets may be different or they can be the same.

Select diversity is particularly advantageous in a cellular radio communications system with limited user-plane mobility functionality in anchor nodes coupled to multiple base stations where at least one base station includes multiple access points. But the technology has wide applicability to all cellular systems because it provides a fast, efficient, and reliable cell change procedure that enables handover without data packet loss or duplication. It also ensures that a mobile radio receives data from a strong cell in the candidate cell set even under fading channel conditions. In contrast to existing soft-handover procedures, the select diversity technology facilitates the independent use of link-adaptation (modulation and coding) as well as multi-user scheduling in each cell.

### BRIEF DESCRIPTION OF THE DRAWINGS

FIG. 1 illustrates a function block diagram of an example handover situation;

FIG. 2 illustrates a transport network for coupling a gateway node and the base stations shown in FIG. 1;

FIG. 3A illustrates two sets of associated wireless access points (APs) forming two broadcast groups connected in this example as subnetworks via corresponding bus segments;

FIG. 3B illustrates two sets of associated wireless access points (APs) forming two broadcast groups connected in this example via satellite broadcast channels;

FIG. 4 illustrates a function block diagram of an example access point;

FIG. 5 illustrates an example packet format with a mobile station identifier;

FIG. 6 illustrates a function block diagram of an example base station having multiple access points showing a mobile station in the process of a handover;

FIG. 7 is a flow chart diagram illustrating non-limiting, example procedures performed in a transport network node;

FIG. 8 is a flow chart diagram illustrating non-limiting, example procedures performed in an access point;

FIG. 9 is a flow chart diagram illustrating non-limiting, example procedures performed in a mobile station;

FIG. 10 is a function block diagram of a non-limiting example mobile radio;

FIGS. 10-18 illustrate example handover situations; and

FIG. 19 illustrates an example embodiment where the mobile selects different packets to be transmitted in parallel from different base stations.

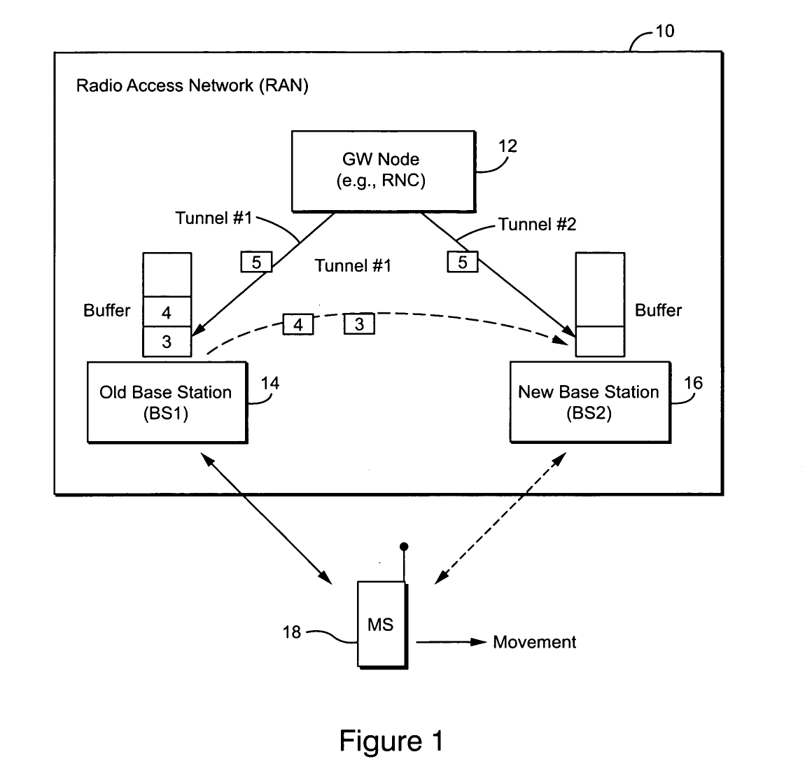

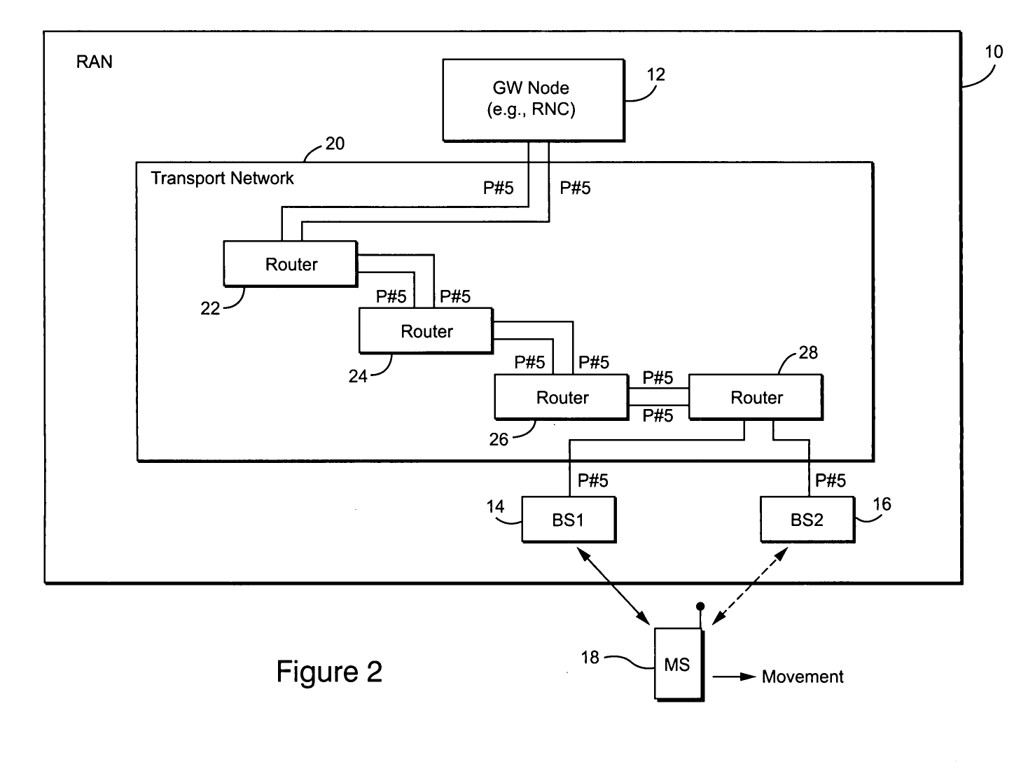

### DETAILED DESCRIPTION

The following description sets forth specific details, such as particular embodiments, procedures, techniques, etc. for purposes of explanation and not limitation. But it will be appreciated by one skilled in the art that other embodiments may be employed apart from these specific details. For example, although the following description is facilitated using a non-limiting example application using Ethernet technology applied to a transport network in a cellular communications network, other data packet broadcast technology may be employed, e.g., satellite, wireless local area network, HSDPA, etc. In addition, Ethernet bus segments are used in the examples below illustrate one way of configuring a broadcast group to simplify the description and to provide a concrete example. But as just explained, a broadcast group is not limited to access points interconnected by a bus segment or to a particular broadcast medium.

In some instances, detailed descriptions of well known methods, interfaces, circuits, and device are omitted so as not obscure the description with unnecessary detail. Moreover, individual blocks are shown in some of the figures. Those skilled in the art will appreciate that the functions of those blocks may be implemented using individual hardware circuits, using software programs and data, in conjunction with a suitably programmed digital microprocessor or general purpose computer, using application specific integrated circuitry (ASIC), and/or using one or more digital signal processors (DSPs).

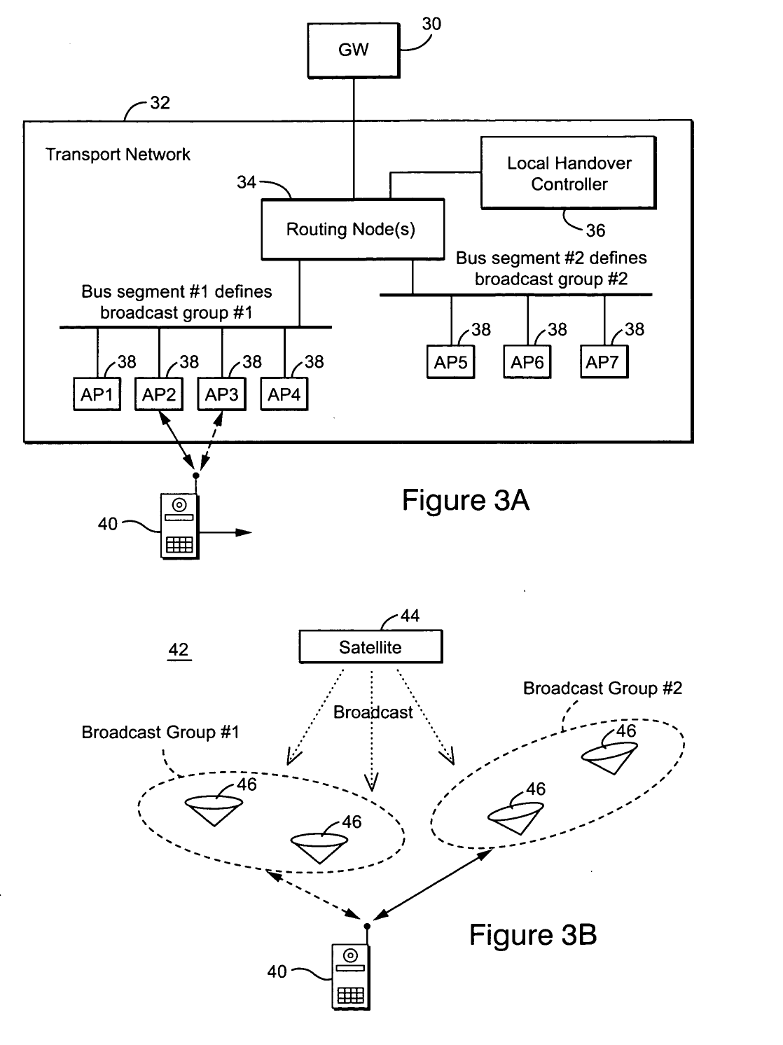

FIG. 3A is a function block diagram of a transport network 32 coupled to a gateway node (GW) 30 and used to facilitate communications with and the mobility of a mobile station 40. In particular, mobile station 40 is moving in the direction indicated by the arrow so that a handover of the mobile connection from access point 2 (AP2) to access point 3 (AP3) is or must soon occur. The transport network 32 includes one or more routing nodes 34 which are coupled to multiple bus segments. Bus segments No. 1 and No. 2 are shown for purposes of illustration which define two broadcast groups of access points. In practice, more than two bus segments may be employed. Each bus segment interconnects multiple access points (AP) 38. Access points AP1 to AP4 are connected as a first set of access points forming a first broadcast group to bus segment No. 1. Access points AP5 to AP7 are coupled as a second set of access points forming a second broadcast group to bus segment No. 2.

The gateway 30 provides packets to the transport network 32 to be routed through the transport network to the appropriate access point for transmission over the radio/air interface to the mobile station 40. Packets that are identified as corresponding to the mobile station 40 by the routing node(s) 34 are routed to bus segment No. 1 and broadcast over the bus segment No. 1 to all of the access points in the first set of access points AP1 to AP4. As one non-limiting broadcasting technique suitable for use with Ethernet bus segments, Ethernet multi-casting may be performed.

Broadcasting packets is particularly advantageous when there is a handover or some other type of cell reselection in which the connection with the mobile station 40 must be transferred between different access points. Since all of the packets for the mobile 40 are broadcast over the bus segment No. 1, all of the access points, including both access points AP2 and AP3, have all the information needed to perform a very fast handover of that connection from AP2 to AP3. Another significant benefit is that there is no need to send several copies of the same packet to each access point that could potentially be involved in a handover. Each packet is. simply broadcast 1 over the bus segment without any additional transport costs.

This broadcasting approach contrasts with the conventional approach in which packet transport connections or “tunnels” must be established to both the access point AP2 as well as to the target access point AP3 for the handover, and in which copies of packets to be transmitted to the mobile and sent over the respective packet transport network connections or tunnels. Alternatively, packets may be forwarded from AP2 to AP3, also resulting in that some packets are passing the broadcast medium or bus segment twice. Thus, the conventional handover approach is much slower and requires significantly more transport costs (e.g., resources, signalling, etc.) to ensure that access points are prepared for potential handovers.

The handover of the mobile station 40 from AP2 to AP3 may be controlled via a local handover controller 36. The local handover controller 36 receives information associated with the mobile station 40 regarding one or more conditions associated with cells in a candidate cell set used for handover operations, e.g., cell load, radio connections, etc. Each of the access points is associated with one or more cell coverage areas. Those access points having cells in the candidate cell set are candidate access points.

When the transport network 32 is initially configured, one possible configuration is to interconnect access points to the same bus segment that have coverage cells located in the same geographical coverage area or approximate geographic coverage areas. Based on the received information regarding one or more conditions associated with cells in the candidate set, the handover controller 36 may add a new cell to the/access point to candidate set, delete and existing cell/access point from the candidate set, or both.

FIG. 3B shows another example where a satellite broadcast transport network 42 is used. A satellite 44 broadcasts packets to either or both of the broadcast groups # 1 and # 2 of terrestrial access points 46. Mobile station 40 is shown communicating with two candidate terrestrial access points 46 in broadcast group # 1. In another non-limiting example (not shown), HSDPA broadcasting could also be used as the broadcast medium in a wireless access network.

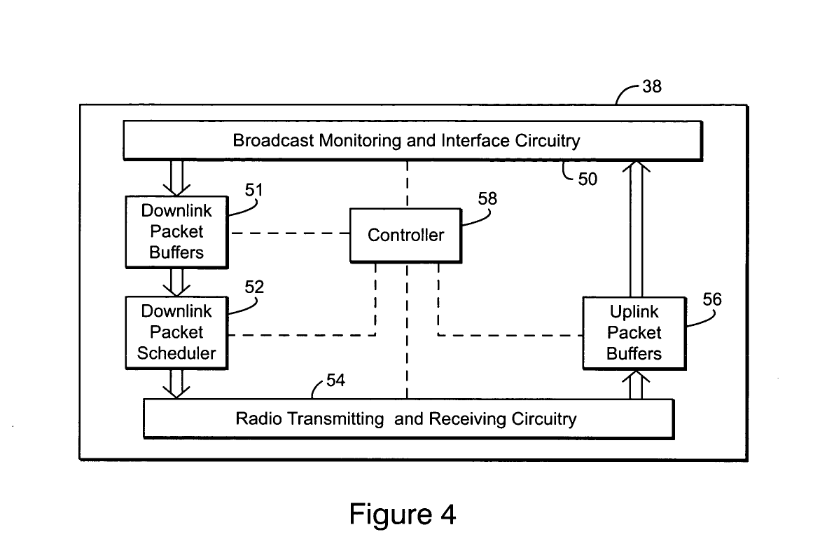

FIG. 4 illustrates a function block diagram of a non-limiting example of an access point 38. Broadcast monitoring and interface circuitry 50 provides packets extracted from the corresponding broadcast group and stores them in an appropriate downlink packet buffer 51. Since each access point may be involved in multiple mobile communications, there will likely be multiple downlink packet buffers or buffer portions, with each buffer or buffer portion storing packets for an associated mobile connection. The downlink packet buffer(s) 51 is coupled to a downlink packet scheduler 52 which provides scheduled packets to radio transmitted and receiving circuitry 54 for transmission over the radio air interface to the appropriate mobile station 40 at the appropriate time. Controller 58 controls the operation of the bus monitoring and interface circuitry 50, the downlink packet buffers 51, the downlink packet scheduler 52, and the radio transmitting and receiving circuitry 54. Uplink packet buffers 56 store packets to be transmitted on the uplink via the bus monitoring and interface circuitry 50.

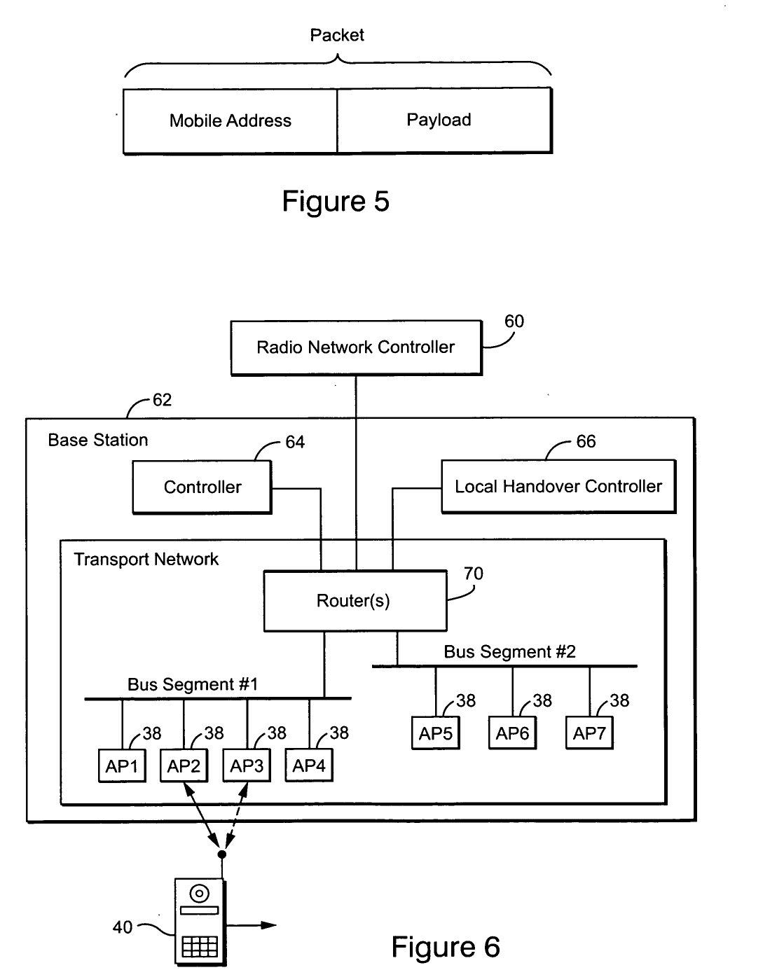

FIG. 5 illustrates an example packet format. The packet includes a mobile address or identifier field along with the remaining contents of the packet labelled as payload. Each access point 38 monitors packets broadcast on its bus segment by comparing the mobile address information of each packet with mobile address information for which it is to retrieve packets from the bus and store in one of its downlink packet buffers. The controller 58 either determines or is informed for example by the local handover controller 36 of which access points should be buffering packets associated with certain mobile station communications. If a mobile identifier match is made, the broadcast monitoring and interface circuitry 50 detects and stores matching packets in the appropriate packet buffer 51 for the mobile. Otherwise, the broadcast monitoring and interface circuitry 50 simply ignores the broadcast packet. The broadcast monitoring circuitry 50 may monitor broadcasts using, for example, a carrier sense multiple access collision detect (CSMA/CD) protocol. However, other protocols could be used.

The controller 58 also monitors access point selection signals to determine whether or not its access point 38 has been selected to transmit a particular packet downlink to the mobile station 40. If some other access point is selected, the controller 58 removes that packet from the buffer 51 and discards it to make room for additional packets. On the other hand, if the access point is selected, either by the mobile station (preferably), by the network, or by some other mechanism, the controller 58 moves that packet into the downlink packet scheduler 52 which schedules its transmission via the radio transmitting and receiving circuitry 54 to the mobile station 40 at the appropriate time.

Although FIG. 3 illustrates that a handover operation occurs between two access points on the same bus segment, the handover could also occur between access points coupled to different bus segments. In that case, packets for the mobile would be broadcast over both of those bus segments. For either situation, because handovers are localized between access points on the same or different bus segments, the handover details are hidden from user-plane entities further up in the node hierarchy above the routing nodes 34. An example of such a higher node is the gateway 30 shown in FIG. 3. As a result, it is possible for these higher level nodes to model the multiple access points as a single base station.

FIG. 6 shows an example base station with multiple access points and bus segments used as one non-limiting example way to form broadcast groups. A non-limiting example of the gateway node is a radio network controller (RNC) 60 coupled to the base station's transport network 68. As mentioned earlier, although the transport network is described here as being part a cellular radio access network, it is not limited to a cellular radio access network. For example, the transport network and access points disclosed in FIGS. 3 and 6 could just as easily be employed in a wireless local area network or in a satellite radio access network. The base station 62 has two bus segments similar to that shown in FIG. 3 being coupled to one or more routers 70. A local handover controller 66 and base station controller 64 are also coupled to the transport network 68.

Given that a single base station could be used to control a larger number of access points, particularly useful applications of the configuration shown in FIG. 6 include office and other indoor environments where the access points could be distributed along bus segments provided along corridors, in rooms, etc. in those environments. The base station functionality may, if desired, be distributed amongst the plural access points with the controller 64 and/or local handover controller 66 distributing and control signalling from nodes higher up in the network hierarchy.

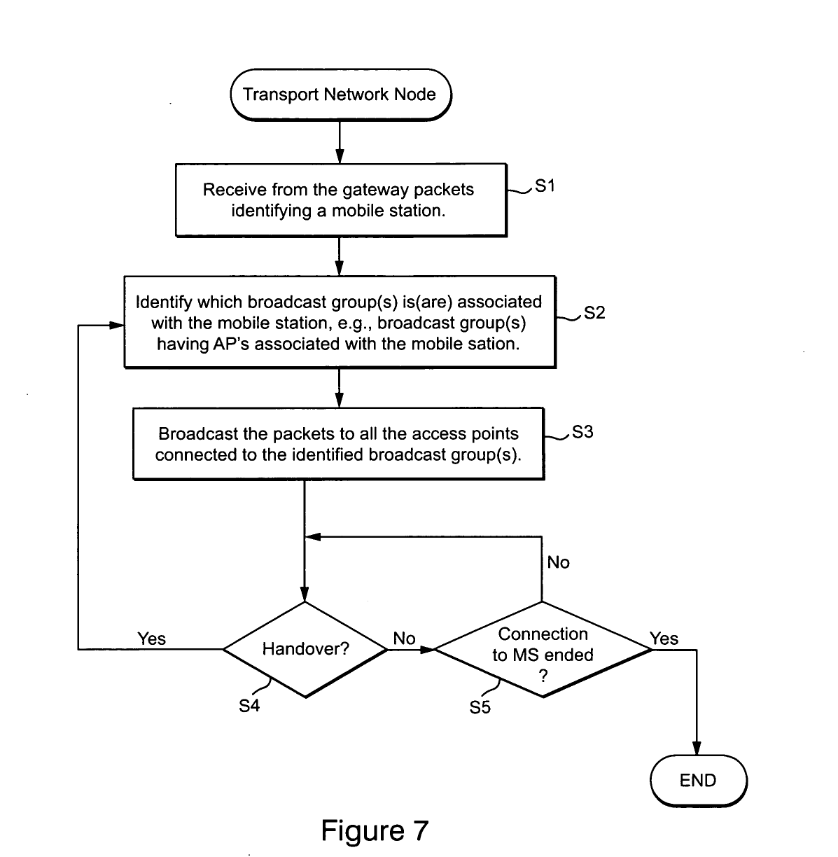

FIG. 7 is a flowchart diagram illustrating non-limiting, example procedures performed in a transport network node such as for example one of the routing nodes 34 and 70 shown in FIGS. 3 and 6 but generalized to broadcast groups. The transport network node receives from the gateway packets identifying a mobile station (step S1). One or more broadcast groups in the transport network associated with the mobile station are identified (step S2). One association would be one or more broadcast groups having access points associated with the mobile station, e.g., the access point is in a candidate set of access points or has a cell in a candidate set of cells associated with the mobile station. The transport network node broadcasts the received packets to all the access points associated with the identified broadcast group(s) (step S3). A decision is made in step S4 whether a handover is to occur. If so, the broadcast group identification process is repeated in step S2 to update the appropriate broadcast group(s) just in case the access points/cells have changed as a result of the handover. If no handover is to occur, a decision is made in step S5 whether the connection to the mobile station has ended. If not, control returns back to the handover decision making step S4. Otherwise, the connection has ended.

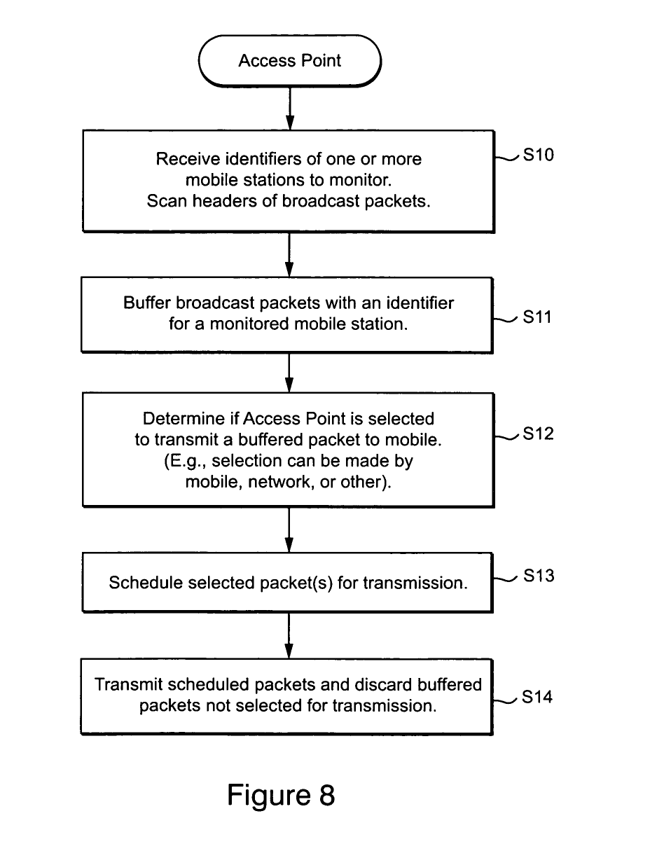

FIG. 8 is a flowchart diagram illustrating non-limiting example procedures that may be performed in an access point. The access point receives identifiers of one or more mobile stations to monitor and scans headers or mobile address fields of broadcast packets (step S10). The access point buffers broadcast packets with an identifier for the mobile station whose ID matches one of the mobile IDs the access point has been monitoring (step S11). The access point determines if it has been selected to transmit a buffered packet to the mobile (step S12). For example, the selection to transmit such a packet may be indicated by the mobile station, the network, or by some other entity. The packet scheduler schedules transmission of selected packets (step S13). The scheduled packets are transmitted, and buffered packets which have not been selected for transmission are discarded (step S14).

The mobile radio 40 monitors the signal quality of downlink transmissions (e.g., on a pilot, broadcast, or other channel) from the current access point (e.g., AP2) serving an active connection with the mobile station as well as from access points associated with neighboring cells (e.g., AP1 and AP3). A candidate set of cells or access points whose transmissions meet one or more specific criteria is maintained for the mobile's connection. Inclusion of access points and/or cells in the candidate set may be based, for example, on a signal to noise ratio (SNR) of the downlink transmission exceeding a threshold, an average SNR remaining above a threshold for some period of time, etc. Similarly, an access point and/or a cell may be removed from the candidate cell set based on one or more criteria. Any suitable candidate set inclusion and removal parameters may be used.

Information of the candidate access point and/or cell sets may be maintained in the mobile station 40, the access point controller 58 or in the local handover controller 36, and in an anchor node (AN) like the gateway 30 (e.g., RNC 60). Candidate cell set additions and/or deletions may be controlled by the anchor node, but may also be assisted by the mobile radio, the access point, or some other control entity. All involved nodes are preferably informed immediately of candidate cell set additions and/or deletions. In a preferred example embodiment, the mobile station 16 reports its cell measurements to a network entity, and the network entity then includes or removes cells to the candidate cell set.

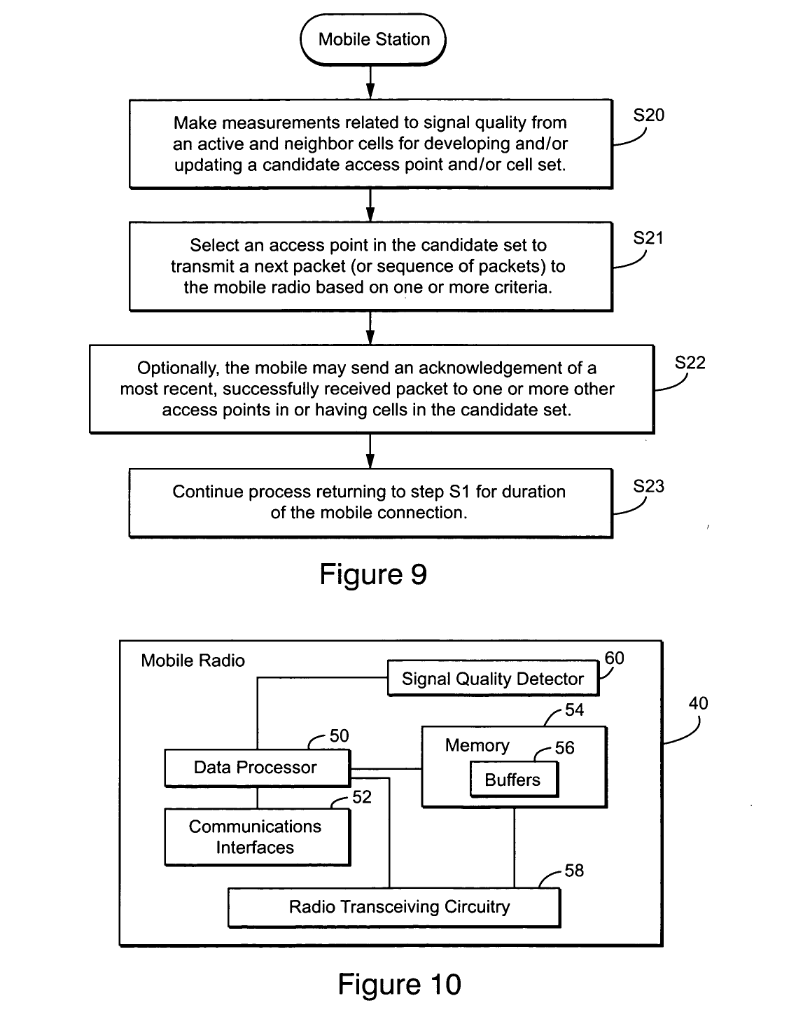

Example non-limiting procedures for the mobile station are now described in conjunction with the flowchart diagram in FIG. 9. Measurements are made related to the signal quality from an active and neighbour cells for developing and updating a candidate cell set (step S20). Other measurements could be made such as cell load, subscription factors like quality of service, etc. One (or more) base stations is selected by the mobile radio from the candidate set to transmit a next packet (or sequence of packets) to the mobile radio based on one or more selection criteria (step S21). Optionally, the mobile radio may send an acknowledgement message for a most recent, successfully received packet to one or more other base stations having cells in the candidate set (step S22). This process is repeated (returning to step S20) for the duration of the mobile radio connection (step S23).

Because the radio base stations may be handling many mobile connections, they may have limited size buffers and some sort of buffer management procedures. One non-limiting, example procedure now explained is front-drop overflow control, although any type of packet flow control can be implemented. The anchor node 18, in turn, sends the packet from the top of its buffer to the base stations having cells in the mobile's candidate set. If the buffer for this mobile connection in any of the radio base stations in the candidate set is full, that buffer simply drops or discards the packet at the top of its buffer to accommodate the new packet.

In one example implementation, the mobile radio requests that the selected radio base station transmit a packet only from the top of its buffer. Otherwise, the base station must “purge” or discard all preceding packets until the packet requested is reached in that transmission buffer. In another example, the radio base station buffers are first-in-first-out (FIFO) buffers that “drop-from-front” at times of buffer overflow.

The packet flow control may optionally include the mobile radio sending an acknowledgement (ACK) signal to a selected base station in the candidate cell set. In response, the base station sends the next packet after the acknowledged packet. Alternatively, a selected base station could simply respond to the mobile's selection by transmitting the next packet in its buffer. Another non-limiting alternative is for the mobile radio to send a selection message to one of the base stations specifying a packet sequence number of the packet to be transmitted. Each access point also includes circuitry for receiving and processing acknowledgements and/or packet sequence numbers from the mobile radio 16.

FIG. 10 is a function block diagram of a non-limiting example mobile radio 40. A data processor 50 is coupled to a memory 54 and a communications interface 52 for communicating with one or more radio base stations 20. The memory 54 stores suitable programs and other software for controlling the processor 50 to perform its required functions and operations. Memory 54 also includes one or more data packet buffers 56 for storing packets to be transmitted to and received from one or more radio base stations in the candidate set. A signal quality detector 60 detects a signal quality of a downlink transmission from each of the cells in its candidate cell set as well as other neighboring cells. Signal quality may be determined using any suitable, e.g., received signal strength, SNR, bit error rate or block error rate, etc. The signal quality measurement information may be sent to the anchor node or some other node to make the candidate set decisions. Alternatively, the processor 50 decides which cells to add to and delete from its candidate set using one or more criteria for evaluating the detected signal qualities so that more optimal cells are included in the candidate cell set and less optimal cells are not.

In select diversity, the mobile's processor 50 selects one or more base station cells from the candidate set to transmit a next packet to the mobile station. The mobile may make those decisions based on current channel qualities (e.g., choose the base station with the best channel quality), on network factors (e.g., cell or system load), subscription factors (e.g., quality of service subscribed to), etc. An indication of that base station cell selection is sent from the mobile so that the selected base station(s) know(s) to transmit a next or specified packet, and un-selected base stations know not to transmit the next packet or specified packet and can remove that packet from their respective transmit buffers. Radio transceiving circuitry 58 is used to transmit and receive information over the radio interface.

The processor 50 may be configured to report an acknowledgement “ACK” of a most recent, successfully-received packet to a “new” radio base station selected for a next packet transmission. In that case, the selected base station can simply send the packet that follows the acknowledged packet. Alternatively, the processor 50 may simply request a next packet, a packet having a particular identifier, or a part of a packet from any radio base station cell in the candidate set without sending such an acknowledgement message.

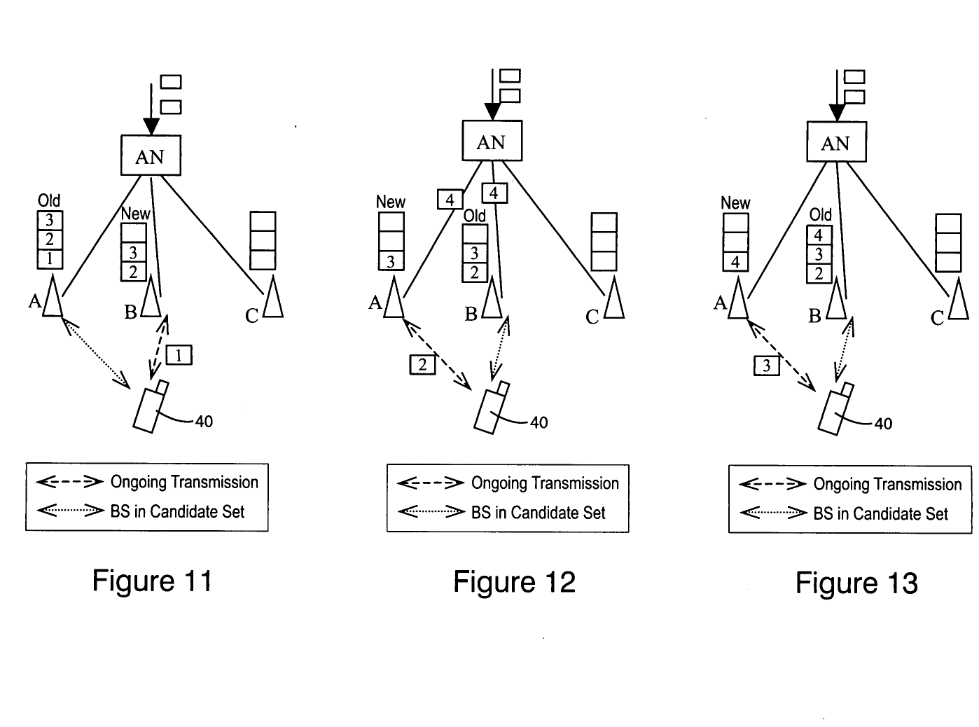

FIGS. 11-18 illustrate example cell reselection/mobility/handover situations. A dashed line in these figures represents an ongoing transmission between an access point and the mobile radio 1. A dotted line between an access point and the mobile radio indicates that a cell governed by the access point is in the active candidate cell set of the mobile radio. A dash-dotted line to and from an anchor node (AN) corresponding to a routing node that is the last “hop” in the transport network. A line marked with a number in a circle indicates a signaling message.

The examples in FIGS. 11-18 each show packets for a mobile radio received at an anchor node. One cell associated with each of the access points A and B is included in the candidate cell set (CS) for an active connection established with the mobile radio. Data packets to be transmitted to the mobile station are sent from the anchor node (AN) to the access points A and B. In this example, the anchor node marks each broadcast packet with a common sequence number. The mobile station periodically checks one or more predefined criteria by which to evaluate the access points in the candidate set (e.g., radio conditions, radio channel quality, instantaneous cell or system load, etc.) and finds the most suitable or best cell within its candidate set for reception of the next packet(s).

For example, in FIG. 11, at the time a packet # 1 is to be transmitted, the mobile station selects, based on e.g. radio link quality, access point and sends an indication to access point B that it has been selected. In this way, the mobile station only has access point B schedule transmission of packet # 1 to the mobile station. But at the next transmission interval shown in FIG. 12, the radio link quality situation has changed with a link to access point A being more favorable that the link to access point B. So the mobile station requests that the access point A schedule transmission of packet # 2 to the mobile radio. Comparing FIGS. 11 and 12, it can be seen that packet # 1 was deleted from access point A without transmission from access point A, because the mobile station indicated that packet # 2 was the next packet to be transmitted from access point A.

In this distributed scheduling environment, different techniques may be used to inform the access point in the candidate set as to which access point will be transmitting the next packet so as to avoid data loss and packet duplications. One technique is for the mobile radio to explicitly indicate in each request to an access point to transmit a packet sequence number or other identifier of a latest, successfully-received packet to a “new” access point so that this “new” access point can schedule transmission of the correct next packet. Another approach is for the mobile radio to request a particular packet, or several successive packets, using the sequence number(s) obtained from an access point in the candidate set. This approach assumes that the mobile radio has received all of its packets up to that sequence number. A third technique keeps the packet transmission with a current access point until the mobile radio informs the access point to stop. In FIG. 12, for example, the mobile could send a “Stop” signal to an “old” selected access point B after receiving packet # 1 and a “Commence” signal to the “new” selected access point A with an “ACK” of packet # 2. Having received that “ACK,” the new access point A schedules transmission to the mobile of the first un-acknowledged packet in its buffer.

“Continuous” transmission from one radio base station is illustrated in the examples in FIGS. 11-14 from access point A illustrated by a dashed line between access point A and the mobile radio. Consequently, the packets in front or top of the buffers in the non-active access points are discarded. In the example figures, the buffers store three packets, although different size buffers may be used. For smaller buffers, a packet flow control (e.g., back-pressure) method may be used, where a transmitting access point informs the anchor node of the available buffer space in its buffer.

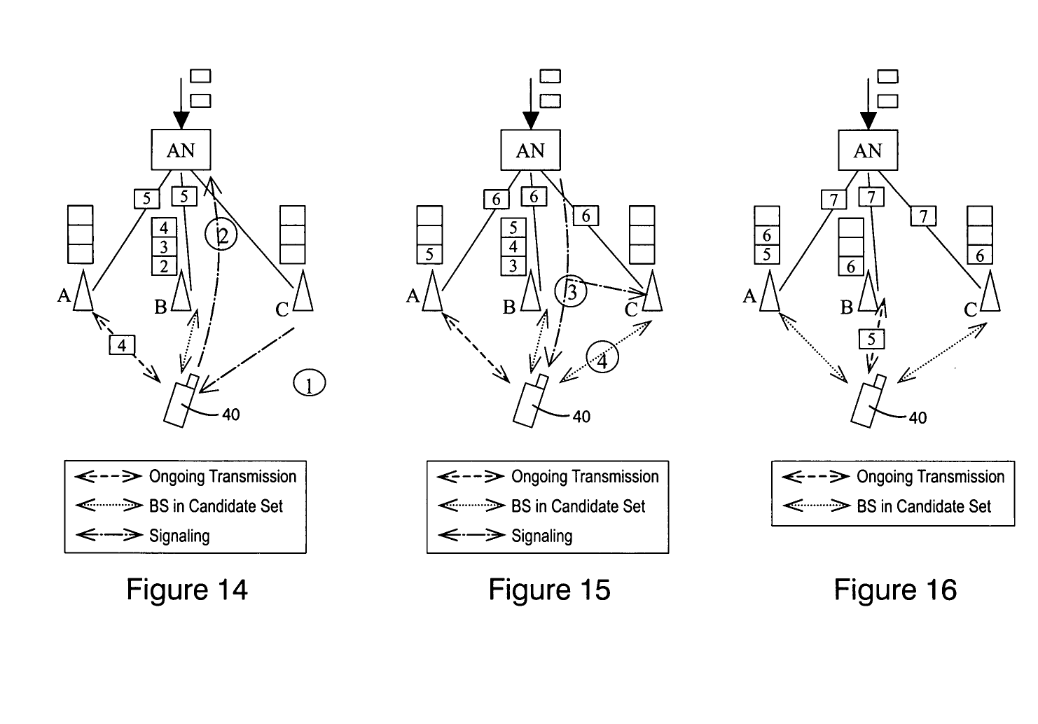

In FIG. 14, the mobile station detects through signal quality measurements that the signal quality associated with the cell governed by access point C has improved (indicated at the signal labelled 1). The mobile station produces a measurement report transmitted to the anchor node (indicated at the signal labelled 2) or any equivalent node responsible for control signalling. Now all access points A, B, and C are included in the mobile 40's candidate set. Meanwhile, the selected packet transmission scheduling continues with access point A transmitting packet # 4 to the mobile 40.

Based on the measurement report, some sort of signal quality threshold(s), and possibly on other criteria, such as, but not limited to, cell load, transport network capacity, etc., the anchor node or other control node includes the cell governed by access point C in the candidate cell set for the mobile radio. This is communicated as shown in FIG. 15 in a signalling message (3) sent to the mobile radio and to the access point C from the access node 18. An advantageous feature to facilitate lossless and seamless transmission in this situation is to include in the message (3) a packet sequence number or other identifier of the first packet that is addressed also to radio base station C. In the illustration shown in FIG. 15, the message (3) identifies packet # 6.

In FIG. 16, even though the access point C is now in the candidate set, the mobile radio maintains its transmission selection with access point B since it is aware that packet # 5 is not available in access point C (observe that the buffer in access point B is purged due to the request of packet # 5). In case of poor link quality (or congestion) to radio base stations A and B, the mobile radio could still select transmission from access point C knowing that the cost is a lost packet #5.

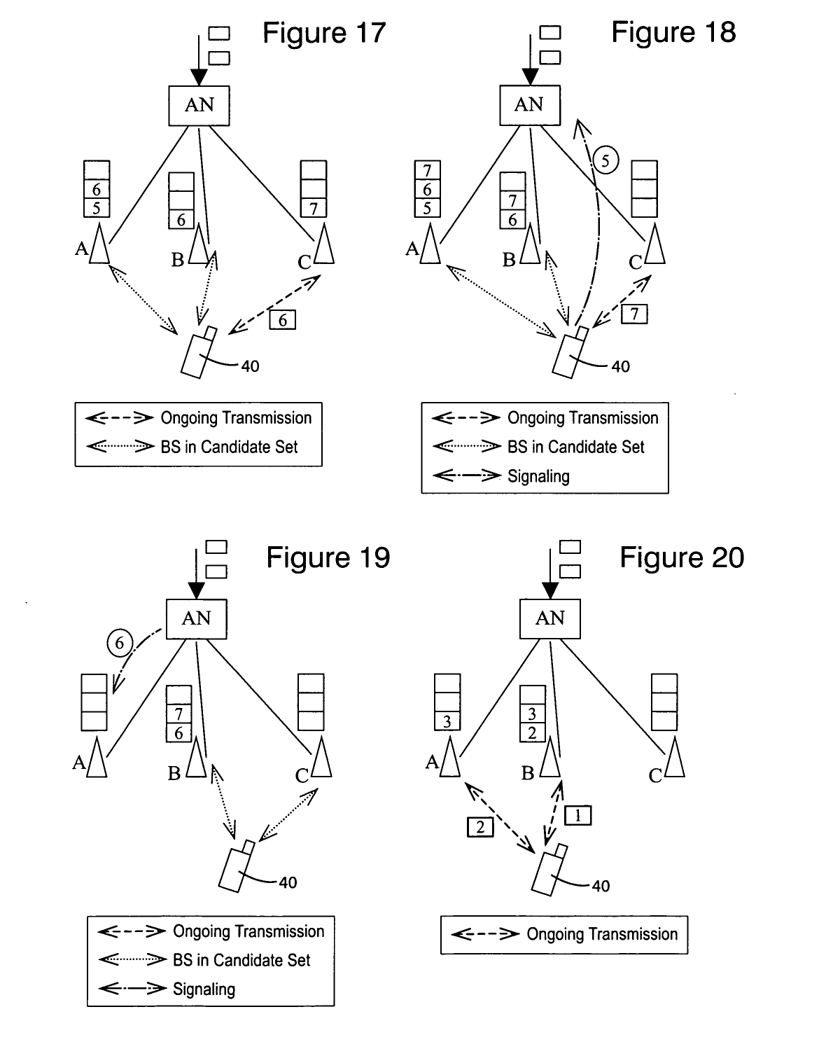

In FIGS. 17 and 18, the mobile radio 16 selects the cell governed by the “new” access point C to transmit packet # 6 and packet # 7, respectively. In FIG. 18, mobile radio measurements of the radio conditions for communicating with access point A indicate a low radio link quality to access point A. The mobile radio sends a measurement report with that link quality information to the anchor node with signalling message 5. In FIG. 19, the access node sends a signalling message 6 to access point A to release access point A as a result of the low quality radio link. Accordingly, access point A is removed from the mobile radio's active candidate access point and/or cell set. Access point A discards any packets stored for this mobile connection and releases the buffer used to hold packets for the connection with the mobile radio.

Another non-limiting example embodiment relates to mobiles capable of receiving two or more data packet streams simultaneously or in parallel. For example, the mobile radio may request transmission of multiple packets from two cells at the same time, as illustrated in the simple example in FIG. 20. Here, the mobile radio requests that packet # 1 be transmitted to the mobile from a cell governed by access point B at the same time as packet # 2 is transmitted by access point A to the mobile radio.

Link layer procedures facilitating the transmission of the referenced packets between the access points and the mobile radio may include—but are not limited to—HARQ between the access point and the mobile radio, link-adaptation for efficient modulation and coding to the prevailing link quality between the selected access point and the mobile radio, and multi-user scheduling. Because packet transmissions from different cells selected by the mobile do not have to be strictly synchronized and coordinated as is required for soft handover, different coding and/or modulation schemes may be used for the different cell transmissions to the mobile radio. Because that strict coordination is not necessary, multi-user scheduling at each base station is much simpler. Uplink transmissions from the mobile radio may also be carried over a connection to the selected cell or over a connection to a different cell within the active candidate cell set.

The select diversity technology described above has many advantages and applications. It involves both the radio network and the mobile radio in the process of obtaining information relevant to candidate cell connections to the mobile and in the process of selecting the best of those cells for and access points a particular packet transmission over that connection. It also provides fast, efficient, and reliable cell change procedure that enables handover without data packet loss or duplication. This is particularly advantageous in a cellular radio communications system with limited user-plane mobility functionality in anchor nodes. The select diversity technology also ensures that a mobile radio receives data from at least a strong cell in the candidate cell set even under fading channel conditions. In contrast to existing soft-handover procedures, the select diversity technology facilitates the use of link-adaptation (modulation and coding) as well as multi-user scheduling from each access point.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. No claim is intended to invoke paragraph 6 of 35 USC §112 unless the words “means for” are used.

1. A radio access network node for supporting mobility of a mobile station communicating with a radio access network via one or more of plural radio access points, where the plural access points include a first set of associated radio access points forming a first broadcast group and a second set of associated radio access points forming a second broadcast group, comprising electronic circuitry configured to perform the following:
receive packets for transmission to the mobile station via one or more of the access points;
identify which broadcast group or groups includes an access point associated with the mobile station;
mark each packet for transmission to the mobile station with an identifier by which an access point can identify packets intended for that access point; and
broadcast one or more of the packets for transmission to the mobile station to the identified broadcast group;
wherein each of the access points in the identified broadcast group receives packets broadcast to the identified broadcast group.

2. The radio access network node in claim 1, wherein the identifier is an identifier specific to the mobile station.

3. The radio access network node in claim 1, wherein the radio access network node is connected to or is a part of a transport network for transporting packets between the access points and the radio access network node, and wherein the electronic circuitry is configured to broadcast packets for the mobile station to access points in the identified broadcast group without having to establish a packet tunnel through the transport network to those access points.

4. The radio access network node in claim 1, wherein the radio access network node is a routing node configured to receive the packets from a gateway node external to the radio access network and route them to the set of associated radio access points in the identified broadcast group.

5. The radio access network node in claim 1, wherein the first set of radio access points in the first broadcast group is associated with coverage cells located in the same geographic coverage area or proximate geographic coverage areas.

6. The radio access network node in claim 1, wherein the electronic circuitry is configured to determine if the access point or access points associated with the mobile station change, and if so, to identify which set of associated radio access points currently includes an access point associated with the mobile station and to notify the access points currently associated with the mobile station to retrieve packets for the mobile station broadcast to those access points.

7. The radio access network node in claim 1, wherein the radio access network is a cellular radio access network or a wireless local area network, and wherein a broadcast medium is satellite, HSDPA, or Ethernet.

8. The radio access network node in claim 1, wherein a broadcast medium is Ethernet and each set of associated radio access points is interconnected by an Ethernet bus segment.

9. A radio access network including the radio access network node in claim 1, wherein each access point is associated with one or more cell coverage areas, comprising:
a handover control node for receiving information associated with the mobile station regarding one or more conditions associated with cells in a candidate set used for handover operations, and for adding a new cell to the candidate set, deleting an existing cell from the candidate set, or both based on the received information.

10. An access point for use in a radio communications with a mobile station and associated with a first set of access points forming a first broadcast group in a transport network, comprising:
broadcast monitoring circuitry for monitoring packets broadcast to the first broadcast group;
a downlink packet buffer connected to the broadcast monitoring circuitry;
control circuitry for providing information to the broadcast monitoring circuitry to detect packets broadcast to the first broadcast group that are intended for the mobile station and controlling the broadcast monitoring circuitry to store detected packets intended for the mobile station in the downlink packet buffer; and
radio transmission circuitry,
wherein the control circuitry is configured to determine if the access point is selected to transmit one of the packets in the downlink packet buffer, and if so, to provide the one packet from the downlink packet buffer to the radio transmission circuitry for transmission to the mobile station.

11. The access point in claim 10, wherein each broadcast packet includes an identifier for identifying that the packet is intended for transmission to a particular mobile station, and wherein the broadcast monitoring circuitry is configured to detect packets intended for the mobile station by checking the identifier of packets broadcast to the first broadcast group with an identifier associated with the mobile station.

12. The access point in claim 10, further comprising:
a downlink packet scheduler, connected to the downlink packet buffer and the radio transmission circuitry, for scheduling transmission of the selected packet to the mobile station.

13. The access point in claim 10, wherein the control circuitry is configured to receive an access point selection signal from the mobile station to transmit a buffered packet to the mobile station.

14. The access point in claim 10, wherein the control circuitry is configured to receive an access point selection signal from a controlling entity in or connected to the transport network to transmit a buffered packet to the mobile station.

15. The access point in claim 10, wherein the access point is associated with one or more cells, wherein a packet communication with the mobile station is associated with a candidate set of cells for the mobile radio that can potentially transmit packets to the mobile radio, and wherein the selection signal identifies a selected one of the candidate cells.

16. The access point in claim 10, wherein the control circuitry is configured to remove and discard packets from the downlink packet buffer that are not selected for transmission to the mobile station.

17. The access point in claim 10, wherein the selection is part of a handover operation or part of a cell selection operation.

18. The access point in claim 10, wherein the selection is based on one or more factors including one or more radio conditions associated with the access point, one or more radio network conditions, or one or more mobile radio subscription conditions.

19. The access point in claim 10, wherein the access point is part of a radio base station that includes a transport network with plural sets of access points each set having a corresponding broadcast group.

20. The access point in claim 10, wherein the broadcast monitoring circuitry is configured to monitor packets broadcast to the first broadcast group using a carrier sense multiple access collision detect (CSMA/CD) protocol.

21. The access point in claim 10, wherein the transport network and the access point are part of a cellular radio access network or a wireless local area network, and wherein a broadcast medium is satellite, HSDPA, or Ethernet.

22. The access point in claim 10, wherein a broadcast medium is Ethernet and each set of associated radio access points in the first broadcast group is interconnected by an Ethernet bus segment.

23. Mobile radio apparatus for facilitating transmission of data packets downlink from a radio access network to the mobile radio, the radio access network including a transport network with plural sets of associated access points, each set forming a corresponding broadcast group, where each access point is associated with one or more cells, and where multiple candidate access points having an associated cell in a candidate set of cells for the mobile station receive packets for the mobile station broadcast over the transport network, comprising:
processing circuitry configured to select one of the candidate access points having a cell in the candidate cell set for transmitting a packet to the mobile radio;
a radio transmitter for signalling from the mobile radio to the selected access point an indication to transmit the packet to the mobile radio; and
a radio receiver for receiving the packet from the selected access point at the mobile radio.

24. The mobile radio apparatus in claim 23, wherein the processing circuitry is configured to select two or more candidate access points having cells in the candidate cell set to transmit the packet to the mobile radio.

25. The mobile radio apparatus in claim 23, wherein the selection is part of a handover operation or part of a cell selection operation.

26. The mobile radio apparatus in claim 23, wherein the processing circuitry is configured to make the access point selection based on one or more factors including one or more radio conditions related to candidate access points, one or more radio network conditions, or one or more mobile radio subscription conditions.

27. A method for supporting mobility of a mobile station communicating with a radio access network via one or more of plural radio access points, where the plural access points include a first set of associated radio access points forming a first broadcast group and a second set of associated radio access points forming a second broadcast group, the method comprising:
receiving packets for transmission to the mobile station via one or more of the access points;
identifying which broadcast group includes an access point associated with the mobile station;
marking each packet for transmission to the mobile station with an identifier by which an access point can identify packets intended for that access point; and
broadcasting one or more of the packets for transmission to the mobile station to the identified forming a first broadcast group, wherein each of the access points in the identified forming a first broadcast group receives packets broadcast to the identified forming a first broadcast group.

28. The method in claim 27, wherein the identifier is an identifier specific to the mobile station.

29. The method in claim 27, wherein the radio access network node is connected to or is a part of a transport network for transporting packets between the access points and the radio access network node, the method further comprising:
broadcasting packets for the mobile station to access points without having to establish a packet tunnel through the transport network to those access points.

30. The method in claim 27, the method further comprising:
routing packets received from a gateway node external to the radio access network through a transport network to the identified broadcast group.

31. The method in claim 27, wherein the first broadcast group is associated with coverage cells located in the same geographic coverage area or proximate geographic coverage areas.

32. The method in claim 27, further comprising:
determining if the access point or access points associated with the mobile station change,
if so, identifying which broadcast group or groups currently includes an access point associated with the mobile station, and
notifying the access points currently associated with the mobile station to retrieve packets for the mobile station broadcast to those radio access points.

33. The method in claim 27, wherein the radio access network is a cellular radio access network or a wireless local area network, and wherein a broadcast medium is satellite, HSDPA, or Ethernet.

34. The method in claim 27, wherein a broadcast medium is Ethernet and each set of associated radio access points in a broadcast group is interconnected by an Ethernet bus segment.

35. The method in claim 27, wherein each access point is associated with one or more cell coverage areas, the method further comprising:
receiving information associated with the mobile station regarding one or more conditions associated with cells in a candidate set used for handover operations, and
adding a new cell to the candidate set, deleting an existing cell from the candidate set, or both based on the received information.

36. A method implemented in an access point for radio communication with a mobile station, where the access point is associated with a first set of radio access points in a transport network and the first set of radio access points corresponds to a first broadcast group, comprising:
monitoring packets broadcast to the first set of radio access points;
providing information to detect packets broadcast to the first set of radio access points that are intended for the mobile station;
storing detected packets intended for the mobile station in a buffer;
determining if the access point is selected to transmit one of the packets in the buffer; and
if so, transmitting the one packet to the mobile station.

37. The method in claim 36, wherein each broadcast packet includes an identifier for identifying that the packet is intended for transmission to a particular mobile station, the method further comprising:
detecting packets intended for the mobile station by checking the identifier of packets broadcast to the first set of radio access points with an identifier associated with the mobile station.

38. The method in claim 36, further comprising:
scheduling transmission of the selected packet to the mobile station.

39. The method in claim 36, further comprising:
receiving an access point selection signal from the mobile station to transmit a buffered packet to the mobile station.

40. The method in claim 36, further comprising:
receiving an access point selection signal from a controlling entity in or connected to the transport network to transmit a buffered packet to the mobile station.

41. The method in claim 36, wherein the access point is associated with one or more cells, wherein a packet communication with the mobile station is associated with a candidate set of cells for the mobile radio that can potentially transmit packets to the mobile radio, and wherein the selection signal identifies a selected one of the candidate cells.

42. The method in claim 36, further comprising:
discarding stored packets that are not selected for transmission to the mobile station.

43. The method in claim 36, wherein the selection is part of a handover operation or part of a cell selection operation.

44. The method in claim 36, wherein the selection is based on one or more factors including one or more radio conditions associated with the access point, one or more radio network conditions, or one or more mobile radio subscription conditions.

45. The method in claim 36, further comprising:
monitoring the bus segment using a carrier sense multiple access collision detect (CSMA/CD) protocol.
